(19) United States
(12) Patent Application Publication
(10) Pub. No.: US 2012/0241636 A1
(43) Pub. Date: Sep. 27, 2012

(54) APPARATUS FOR MEASURING COMPOUND USING PHOTO-IONIZATION DETECTOR

(75) Inventors: Jae-Kyoung Ahn, Incheon (KR); Sang-Jun Choi, Daegu (KR)

(73) Assignee: Jae-Kyoung AHN, Incheon (KR)

(21) Appl. No.: 13/514,595

(22) PCT Filed: May 27, 2010
(86) PCT No.: PCT/KR2010/003350

§ 371 Date: Jun. 7, 2012

(30) Foreign Application Priority Data
Dec. 7, 2009 (KR) 10-2009-0120523

(51) Int. Cl. G01T 1/185

(52) U.S. Cl. 250/389

(57) ABSTRACT

The present invention relates to an apparatus for measuring a compound using a photo-ionization detector. The apparatus comprises: an ultra violet (UV) lamp (10) which is filled with a krypton gas as an inert gas and emits UV light of 10.6 eV; a photo-ionization detector (PID) unit (100) which detects a compound (50) ionized by the UV lamp; a delay unit (200) which delays the compound (50) ionized through the PID unit so as to change the ionized compound into the original compound; and a collection unit (300) for collecting the compound (50) outputted through the delay unit. Accordingly, the PID unit is connected through the delay unit to the collection unit so that the compound which is quantitatively analyzed by the PID unit can be grasped in detail by the collection unit. In addition, the collection unit having only a qualitative analysis function is connected with the PID unit so that the concentration change of the compound which is qualitatively analyzed by the collection unit can be grasped in real time.

### TECHNICAL FIELD

The present invention relates to a measuring device of compounds using a photo-Ionization detector which comprises a photo ionization detection part (PID) (100) which includes an ultraviolet ray (UV) lamp (10) which is filled with a krypton gas which is an inert gas and emits an ultraviolet ray of an energy of 10.6 eV; and an anode (30) and a cathode (40) which are installed at the front side of the ultraviolet ray lamp (10) and are insulated by an insulated part (20), thus detecting the compound substance (50) ionized by means of the ultraviolet ray lamp; a delay part (200) which delays the ionized compound substance (50) to return to the original substance through the photo ionization detection part; and a collection part (300) which collects the compound substance (50) which has passed through the delay part.

### BACKGROUND ART

The concentration is approximately measured at a site with a photo-ionization meter in a conventional art, and a collection column is exposed for a certain time at a site, and the composition of the collected compounds are measured using a gas chromatography.

The photo-ionization measuring method, which makes available a quantitative analysis of a compound substance, is able to measure in real time the concentration of a compound floating in the air; however it is impossible know what compound substance is being measured.

The collection column method, which makes available a qualitative analysis of a compound substance, is able to analyze the components of each substance of the compound substances floating in the air; however it is impossible to know a real-time concentration change of a compound substance which is being measured.

### DISCLOSURE OF INVENTION

Accordingly, the present invention is made to resolve the above-mentioned problems. It is an object of the present invention to provide a measuring device of compounds using a photo-Ionization detector which makes it possible to know what compound substance is being quantitatively analyzed by a photo ionization detection part because a photo ionization detection part is connected with a delay part via a collection part, and to know a real time concentration change of a compound substance which is qualitatively analyzed by a collection part in such a way that a collection part, which used to perform only a qualitative analysis, is connected with a photo ionization detection part.

To achieve the above objects, there is provided a measuring device of compounds using a photo-Ionization detector which comprises a photo ionization detection part (PID) (100) which includes an ultraviolet ray (UV) lamp (10) which is filled with a krypton gas which is an inert gas and emits an ultraviolet ray of an energy of 10.6 eV; and an anode (30) and a cathode (40) which are installed at the front side of the ultraviolet ray lamp (10) and are insulated by an insulated part (20), thus detecting the compound substance (50) ionized by means of the ultraviolet ray lamp; a delay part (200) which delays the ionized compound substance (50) to return to the original substance through the photo ionization detection part; and a collection part (300) which collects the compound substance (50) which has passed through the delay part.

In addition, the delay part (200) is formed in a spiral shape, thus delaying a delay time, and the collection part (300) is filled with one selected from the group consisting of active carbon, silica gel, aluminum oxide and magnesium oxide.

### ADVANTAGEOUS EFFECTS

The present invention is advantageously characterized in that it is possible to know what compound substance is being quantitatively analyzed by a photo ionization detection part because a photo ionization detection part is connected with a delay part via a collection part, and to know a real time concentration change of a compound substance which is qualitatively analyzed by a collection part in such a way that a collection part, which used to perform only a qualitative analysis, is connected with a photo ionization detection part.

### BRIEF DESCRIPTION OF DRAWINGS

FIG. 1 is a cross sectional view illustrating a measuring device of compounds using a photo-Ionization detector according to an embodiment of the present invention.

FIG. 2 is a perspective operation view illustrating a photo ionization detection part of a measuring device of compounds using a photo-Ionization detector according to an embodiment of the present invention.

FIG. 3 is a view of a chemical change of a chemical substance at a photo ionization detection part of a measuring device of compounds using a photo-Ionization detector according to an embodiment of the present invention.

FIG. 4 is an ionization energy graph of a compound substance which can be measured by a measuring device of compounds using a photo-Ionization detector according to an embodiment of the present invention.

### MODES FOR CARRYING OUT THE INVENTION

The present invention will be described in details with reference to the accompanying drawings. The same reference numerals in each drawing are meant to be the same elements.

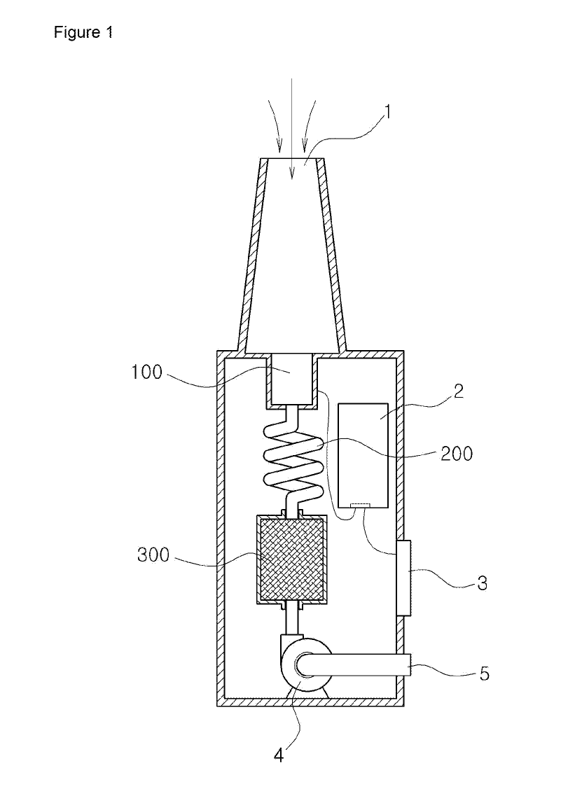

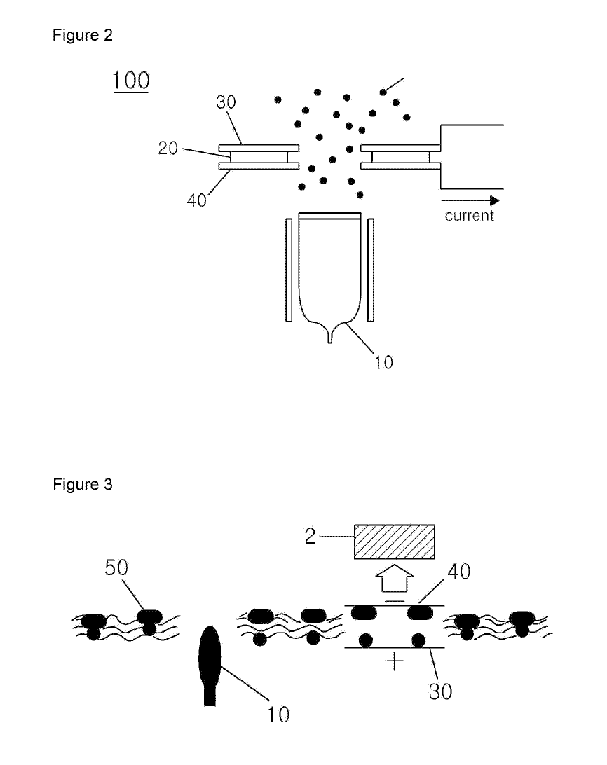

FIG. 1 is a cross sectional view illustrating a measuring device of compounds using a photo-Ionization detector according to an embodiment of the present invention. FIG. 2 is a perspective operation view illustrating a photo ionization detection part of a measuring device of compounds using a photo-Ionization detector according to an embodiment of the present invention. FIG. 3 is a view of a chemical change of a chemical substance at a photo ionization detection part of a measuring device of compounds using a photo-Ionization detector according to an embodiment of the present invention.

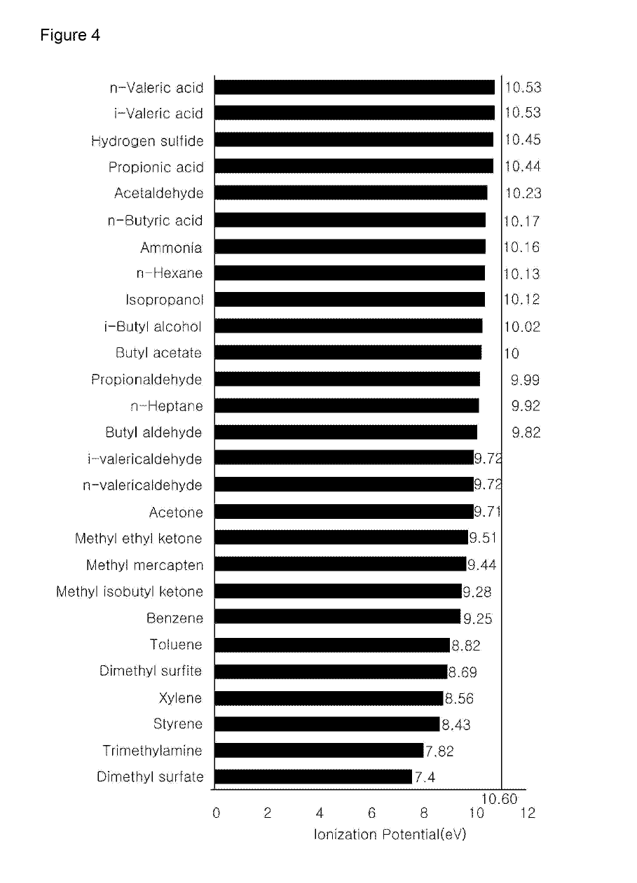

In addition, FIG. 4 is an ionization energy graph of a compound substance which can be measured by a measuring device of compounds using a photo-Ionization detector according to an embodiment of the present invention.

As shown in FIGS. 1 to 4, the measuring device of compounds using a photo ionization detector according to a preferred embodiment of the present invention comprises a photo ionization detection part 100, which is formed of a ultraviolet ray lamp 10, an insulated part 20, an anode 30, and a cathode 40, and a delay part 200 and a collection part 300.

The measuring device of compounds using a photo ionization detector according to a preferred embodiment of the present invention further comprises an inlet part 1, a controller 2, an operation part 3, a suction part 4 and a discharge part 5.

As shown in FIG. 1, the measuring device of compounds using a is photo ionization detector according to the present invention is operated by the operation part 3, and an external air is sucked into the suction part 1 by means of a suction force of the suction part 4, and the thusly sucked air reaches the photo ionization detection part 100. The compound substance having an ionization energy smaller than the discharge energy of the ultraviolet ray lamp 10 positioned in the interior of the photo ionization detection part 100 among the air which has reached the photo ionization detection part 100 is ionized by the ultraviolet ray lamp 10. The ionized compound substance corresponds to an ordinary compound substance, and a change in the level of the current flowing depending on the concentration of the ionized compound substance is detected by means of a detector positioned in the interior of the photo ionization detection part 100. Afterward, the change in the level of the current detected by means of the photo ionization detection part 100 is indicated on the controller 2 connected with the photo ionization detection part 100.

In addition, the compound substance 50 passed through the photo ionization detection part 100 flows past the delay part 200 connected with the photo ionization detection part 100 and is inputted into the collection part 300 connected with the delay part 200. The collection part 300 filled with a filler capable of adsorbing the compound substances adsorbs the compound is substances inputted into the collection part 300. Afterward, the air passed through the collection part 300 is discharged to the outside by means of the discharge part 5.

The operations of the photo ionization detector (PID) adapted in the present invention will be first described. As shown in FIG. 2, the photo ionization detection part 100 comprises a UV (Ultraviolet) lamp 10 emitting an ultraviolet ray into the air containing the compound substance whose concentration is to be measured, and an anode 30 and a cathode 40 which are installed at a front side of the ultraviolet ray lamp 10 and are insulated from each other by means of the insulated part 20.

When selecting the filler of the ultraviolet lamp 10, the air is a main composition, and nitrogen and oxygen gases having ionization energy of 15.5 eV and 12.0 eV are not ionized. As shown in FIG. 4, the filler is preferably selected from the compound groups consisting of dimethyl sulfate, trimethylamine, styrene, xylene, dimethyl sulfide, methyl isobutyl ketone, methyl ethyl ketone, n-valeric aldehyde, i-valeric aldehyde, butyl aldehyde, propionaldehyde, butly acetate, i-butyl alcohol, ammonia, n-butyric acid, acetaldehyde, propirinic acid, hydrogen sulfide, i-valeric acid and n-valeric acid. It is preferred that the ultraviolet ray lamp 10 is filled with krypton gas which is inert gas, thus discharging an ultraviolet ray of 10.6 eV energy.

So, the ultraviolet lamp filled with krypton gas ionizes the compound having below 10.6 eV of ionization energy, and the compound substance having an ionization energy exceeding 10.6 eV is not ionized by the ultraviolet ray lamp filled with krypton gas.

In addition, the ionization energy of the compound substance is meant to be an energy which is needed to take off one electron from an atom or a molecular which is at a bottom state and to fully separate into one positive ion and a free electron. Since the ionization energy of the compound substance is not an energy breaking a covalent bond which is a coupling between the atoms, when the compound substance whose free electron is separated by the ultraviolet ray lamp becomes distant from the ultraviolet ray lamp, it takes a free electron from the outside and returns to the original stable state, which is schematically shown in FIG. 3.

Next, as shown in FIG. 2, when a voltage is applied to the anode 30 and the cathode 40, in the compound substance 50 ionized by means of the ultraviolet ray lamp 10, the positive ion is collected at the cathode 40, and the negative ion is collected at the anode 30, respectively, thus generating current. The size of the thusly generated current is in proportion to the concentration of the compound substance; however considering that the quantity of the current generated is very small, it is preferred to amplify a voltage signal with an amplification and conversion means and then measure it. In this case, the amplification and conversion means might be implemented in various forms in such a way to combine the current/voltage converter and the amplifier. Since the technology for configuring the amplification and conversion means is well known in the art, so the detailed descriptions thereof will be omitted.

Next, the delay part 200 is connected with the photo ionization detection part 100. The compound substance 50 ionized by the ultraviolet ray lamp 10 flows into the delay part 20 and has a free electron while staying in the delay part 200, thus returning to the original stable state. It is preferred that the delay part 200 is formed in a spiral shape so that the ionized compound substance 50 stays long enough and can return to the original stable state.

In addition, the collection part 300 is connected with the delay part 200 and is characterized in that it is filled with one selected from the group consisting of active carbon, silica gel, aluminum oxide and magnesium oxide. The compound substance 50, which has returned to the original compound substance while passing past the delay part 200 flows into the collection part 300 and is adsorbed by the filler. In addition, it is preferred that the collection part 300 is separated after a certain time and then the component of the compound substance 50 is analyzed.

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

1. A measuring device of compounds using a photo-Ionization detector, comprising:
a photo ionization detection part (PID) (100) which includes:
an ultraviolet ray (UV) lamp (10) which is filled with a krypton gas which is an inert gas and emits an ultraviolet ray of an energy of 10.6 eV; and
an anode (30) and a cathode (40) which are installed at the front side of the ultraviolet ray lamp (10) and are insulated by an insulated part (20), thus detecting the compound substance (50) ionized by means of the ultraviolet ray lamp;
a delay part (200) which delays the ionized compound substance (50) to return to the original substance through the photo ionization detection part; and
a collection part (300) which collects the compound substance (50) which has passed through the delay part.

2. The measuring device of compounds using a photo-Ionization detector according to claim 1, wherein said delay part (200) is formed in a spiral shape, thus delaying a delay time.

3. The measuring device of compounds using a photo-Ionization detector according to claim 1, wherein said collection part (300) is filled with one selected from the group consisting of active carbon, silica gel, aluminum oxide and magnesium oxide.
